(19) United States
(12) Patent Application Publication
(10) Pub. No.: US 2024/0187657 A1
(43) Pub. Date: Jun. 6, 2024

(54) IMAGE FRAME STREAMING SYTEM

(71) Applicant: Zimeno Inc., Livermore, CA (US)

(72) Inventors: Sanket GOYAL, Pleasanton, CA (US); Sadasivudu MALLADI, San Jose, CA (US)

(73) Assignee: Zimeno Inc., Livermore, CA (US)

(21) Appl. No.: 18/525,663

(22) Filed: Nov. 30, 2023

Related U.S. Application Data
(60) Provisional application No. 63/534,154, filed on Aug. 23, 2023.
(60) Provisional application No. 63/429,168, filed on Dec. 1, 2022.

(51) Int. Cl. H04N 21/2187

(52) U.S. Cl. CPC H04N 21/2187

(57) ABSTRACT

An image frame streaming system may include a vehicle, a video camera carried by the vehicle to output image frames, a multi-media framework carried by the vehicle and configured to generate a first stream and a second stream from the image frames, a first consumer to receive the first stream and a second consumer to receive the second stream. The first consumer and the second consumer are each selected from a group of consumers consisting of: a neural network; a live video stream presenter; and a historical time clip storage.

### CROSS-REFERENCE TO RELATED PATENT APPLICATIONS

The present non-provisional application claims priority from co-pending U.S. provisional patent application Ser. No. 63/429,168 filed on Dec. 1, 2022, by Goyal et al. and entitled ADAPTIVE LIVE STREAMING, and co-pending U.S. provisional patent application Ser. No. 63/534,154 filed on Aug. 23, 2023, by Gatten et al. and entitled VEHICLE CONTROL, the full disclosures of which are hereby incorporated by reference.

### BACKGROUND

Vehicles, ground and airborne, come in a variety of forms such as tractors, semi-trailers, cement mixers, trucks, harvesters, sprayers, construction vehicles, drones, planes, helicopters and the like. Such vehicles may have a variety of operational parameters and may conduct a variety of different operations. Managing and analyzing their operations is sometimes challenging, but may offer opportunities for enhanced automation, land, vineyard, crop or orchard management, vehicle maintenance, operator assignment, vehicle design, and vehicle use.

### BRIEF DESCRIPTION OF THE DRAWINGS

FIG. 1 is a diagram schematically illustrating portions of an example image frame streaming system.

FIG. 2 is a diagram schematically illustrating portions of an example image frame streaming system.

FIG. 3 is a flow diagram of an example image frame streaming method.

FIG. 4 is a diagram schematically illustrating portions of an example image frame streaming system.

FIG. 5 is a perspective view of an example vehicle including an example image frame streaming system.

FIG. 6 is a diagram schematically illustrating portions of the example vehicle and the example image frame streaming system of FIG. 5.

FIG. 7 is a diagram schematically illustrating portions of the example vehicle and the example image frame streaming system of FIG. 5.

FIG. 8 is a diagram schematically illustrating portions of the example image frame streaming system of FIG. 5.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example image frame streaming systems, image frame streaming vehicles and image frame streaming methods that facilitate sub second latency camera frame transmission. The example systems, vehicles and methods facilitate such sub second latency camera frame transmission for multiple cameras situated on a vehicle. The example systems, vehicles and methods utilize a multimedia framework that supports hardware encoding to compress live resolution frames or streams. Such streams have low latency and are optimized for adaptive bandwidth control. As result, there is minimal loss of frames, and the quality of the live feed is maintained throughout.

The example image frame streaming systems, image frame streaming vehicles and image frame streaming methods use a multimedia framework carried by the vehicle to generate multiple streams from image frames received from a video camera of the vehicle. In some implementations, all of the streams are formed from the same set of image frames. In other words, the source image frames used for generating each of the streams is identical. The streams are transmitted to at least two different consumers, wherein the consumers consist of a neural network, a live video stream presenter and/or a historical time clip storage.

In particular examples, a WebRTC framework is used. In particular examples, a Janus-Gateway provides the WebRTC solution. The Janus-Gateway may be installed on the vehicle server. On the other side of the Web app and Mobile app, a HTTP request may be sent to the Janus-Gateway to establish connection between the vehicle server and the mobile app on the operator's browser. In such examples, a relay server or a Traversal Using Relays around NAT (TURN) server is employed. In some implementations, the TURN server may be developed using Amazon Elastic Computer Cloud (AWS).

For purposes of this application, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random-access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, unless otherwise explicitly set forth, the recitation of a “processor”, “processing unit” and “processing resource” in the specification, independent claims or dependent claims shall mean at least one processor or at least one processing unit. The at least one processor or processing unit may comprise multiple individual processors or processing units at a single location or distributed across multiple locations.

For purposes of this disclosure, the phrase “configured to” denotes an actual state of configuration that fundamentally ties the stated function/use to the physical characteristics of the feature proceeding the phrase “configured to”.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

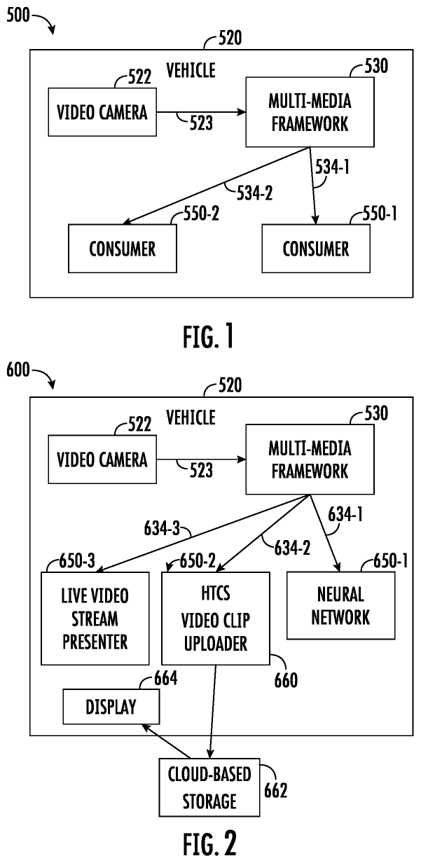

FIG. 1 is a diagram schematically illustrating portions of an example image frame streaming system 500. System 500 comprises vehicle 520, video camera 522, multimedia framework 530, and consumers 550-1, 550-2 (collectively referred to as consumers 550). Vehicle 520 comprises a vehicle in the form of a tractor, semi-trailer, cement mixer, truck, harvester, sprayer, construction vehicle, drone, plane, helicopter and the like, or any other vehicle for which cameras are provided to provide image frames for image frame streaming and other uses.

Video camera 522 comprise a camera carried by vehicle 520 configured to output image frames. Video camera 522 may be in the form of a 3D or stereo camera or a two-dimensional camera. In some implementations, vehicle 520 may comprise multiple video cameras 522.

Multimedia framework 530 is carried by vehicle 520 and is configured to generate image streams 534-1 and 534-2 (collectively referred to as image streams 534) from the image frames 523 received from video camera 522. In some implementations, multimedia framework 530 comprises a GStreamer pipeline-based multimedia framework. Streams 534-1 and 534-2 are transmitted to consumers 550-1 and 550-2, respectively.

Consumers 550 utilize streams 534 of images to carry out various tasks. Each of consumers 550 is selected from a group of consumers consisting of: a neural network, a live video stream presenter and a historical time clip storage. In some implementations, the neural network utilizes the stream of images or image frames to train a deep learning network and/or to analyze such images using an already trained network to carry out automated control of vehicle 520. In some implementations, the live video stream presenter provides a live sub second latency camera frame transmission to an operator, residing either locally on vehicle 520 or at a remote location. In some implementations, the historical time clip storage facilitates recording and storage of image frames for subsequent viewing and analysis.

In some implementations, the live video stream presenter may comprise a web real time communications (RTC) server carried by the vehicle. In some implementations, the web RTC server may comprise a Janus Gateway server. In some implementations, the live stream video presenter may comprise a cloud-based media server that is to receive a first stream from the web RTC server and a live stream display device to receive the first stream from the media server and display the live stream to a person.

In some implementations, the historical time clip storage may comprise a video clip up loader carried by the vehicle and configured to receive a video clip based upon the stream. The historical time clip storage may further comprise a cloud-based storage configured to receive the video clip from the video clip up loader and a video clip display device to receive the video clip from the cloud-based storage and display the video clip to a person.

FIG. 2 is a diagram schematically illustrating portions of an example image frame streaming system 600. System 600 is similar to system 500 except that system 800 specifically comprises image frame stream consumers 650-1, 650-2 and 650-3 (collectively referred to as consumers 650) in place of consumers 550. Those remaining components of system 600, which correspond to components of system 700 are numbered similarly and are described above with respect to system 700. As shown by FIG. 2, multimedia framework 530 is configured to generate streams 634-1, 634-2 and 634-3 (collectively referred to as streams 634) from image frame 523 received from video cameras 522 and which are transmitted to consumers 650-1, 650-2 and 650-3, respectively.

Consumer 650-1 comprises a neural network (also referred to as machine learning). The neural network utilizes the stream of images or image frames to train a deep learning network and/or to analyze such images using an already trained network to carry out automated control of vehicle 520.

Consumer 650-2 comprises a historical time clip storage (HTCS). The historical time clip storage 650-2 comprises a video clip up loader 860, a cloud-based storage 662 and a display 664. Video clip uploader 660 is configured to receive or generate a video clip from stream 634-2. Uploader 660 is further configured to upload the video clip to cloud-based storage 662. Display 864 comprises a display in communication with the cloud-based storage 662 and is configured to receive the video clip from the cloud-based storage 662 (a remote server) and to present the video clip to a person. Display 664 may be local, carried by vehicle 520, or may be remote for presenting the video clip to a remote operator or manager of vehicle 520.

Live video stream presenter 650-3 receives stream 634-3 and presents a sub second latency video stream to a person such that the person can see what the camera is seeing, live or in real time. Live video stream presenter 650-3 may include a display for presenting the live video stream. The display may be the same as display 664 or may be a separate display. The display may be one that is located on vehicle 520 or one that is remote from vehicle 520.

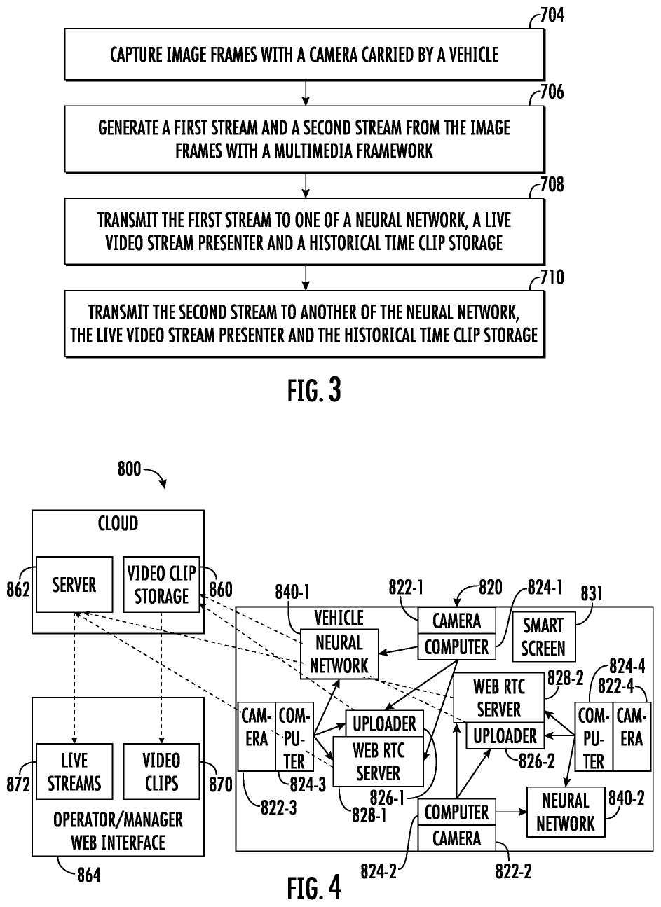

FIG. 3 is a flow diagram of an example image frame streaming method 700 and may be carried out by systems 500, 600 or systems described hereafter. As indicated by block 704, a camera carried by a vehicle, such as vehicle 520, captures image frames. The camera may be similar to video cameras 522 described above.

As indicated by block 706, a multimedia framework generates a first stream and a second stream from the image frames captured in block 704. As indicated block 708, the first stream is transmitted to one of a neural network, a live video stream presenter and a historical time clip storage. As indicated by block 710, the second stream is transmitted to another of the neural network, the live video stream presenter and the historical time clip storage.

In some implementations, a computer associated with the camera transmits the first stream to the neural network and transmits a second stream to a web real time communication (RTC server) which then transmits the second stream to a cloud-based live video stream server, wherein the live video stream or the video clip on the cloud-based server may be transmitted/downloaded to a web interface of an operator/manager. In some implementations, the computer associated with the camera further transmits a third stream to a video up loader which uploads video clips to the cloud-based historical time clip storage, wherein the video clips may be transmitted/downloaded to the web interface of the operator/manager.

FIG. 4 is a diagram illustrating portions of an example image frame streaming system 800. FIG. 4 illustrates an example of how a vehicle may be provided with multiple cameras and associated computers to concurrently transmit streams of image frames to a neural network, an up loader for uploading video clips to a cloud-based video clip storage and to a web RTC server for transmitting live video streams to a cloud-based server for subsequent downloading or transmission to a web interface of an operator/manager. FIG. 4 illustrates how web RTC servers and uploaders may be shared amongst multiple cameras and computers on a vehicle and how a cloud service may be utilized to provide an operator/manager with live streams and access to stored video clips using a web interface. Image frame streaming system 800 comprises vehicle 820, video cameras 822-1, 822-2, 822-3, and 822-4 (collectively referred to as cameras 822), computing devices or computers 824-1, 824-2, 824-3 and 824-4 (collectively referred to as computers 824), up loaders 826-1, 826-2 (collectively referred to as up loaders 826), web RTC servers 828-1, 828-2 (collectively referred to as servers 828), smart screen 831, neural networks 840-1, 840-2 (collectively referred to as neural networks 840), historical time clip storage 860, live video stream presenter 862 (in the form of a server) and operator/manager web interface 864.

Vehicle 820 is similar to vehicle 520 described above. Vehicle 820 may be in the form of a tractor, semi-trailer, cement mixer, truck, harvester, sprayer, construction vehicle, drone, plane, helicopter and the like.

Video cameras 822 are similar to video cameras 522 described above. Video cameras 822-1 and 822-2 may face in a sideways direction. Video camera 822-3 may face in a forward direction, either at an angle or parallel to the longitudinal axis of vehicle 820. Video camera 822-4 faces in a rearward direction, at a rearward angle or parallel to the longitudinal axis of vehicle 820.

Computers 824 are provided for each of cameras 822. Computers 824 received image frames from their respective cameras and output image frames streams. In the example illustrated, computers 824 output, directly or indirectly, three streams: a first stream which is transmitted to a neural network 840, a second stream which is transmitted to an up loader 826 and a third stream which is transmitted to a web RTC server 828. In the example illustrated, computers 824 may further submit ROS frames to the smart screen 831 for display. Such computers 824 may be part of a multimedia framework such as G streamer.

Up loaders 826 receive video clips (a consecutive series of image frames) and wirelessly communicate such video clips to the video clip storage 860 located in the cloud. Such video clips 870 are then made available to an operator using web interface 864.

Web RTC servers 828, which may be in the form of Janus Gateways, wirelessly communicate the stream of image frames to the live video stream presenter 862 on the cloud. The live video stream presenter 862 may be in the form of a TURN server. The live video stream presenter 862 provides live streams 872 to an operator/manager or other person via web interface 864.

As shown by FIG. 4, cameras 822-2 and 822-4 as well as their associated computers 824-2 and 824-4 share up loader 862-2 and web RTC server 828-2. Likewise, cameras 822-1 and 822-3 as well as their associated computers 824-1 and 824-3 share up loader 862-1 and web RTC server 828-1. Image frames streams are provided to a neural network 840 on the vehicle 820 and to a smart screen 831 on the vehicle 820. At the same time, image frame streams, live streams and video clips, are transmitted to a server 862 and storage 860 for availability on web interface 864.

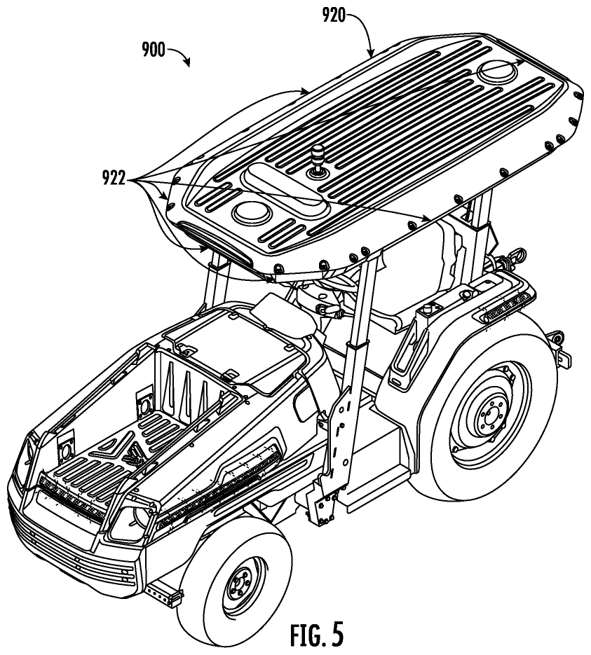

FIG. 5 illustrates an example image streaming system 900 comprising vehicle 920 in the form of a tractor having multiple cameras 922. Although illustrated as a tractor, the vehicle 920 may alternatively comprise other forms such as a truck, a passenger automobile, a harvester, construction equipment, or other forms of agricultural, construction, commercial or other vehicles that may employ one or more cameras that offer image frame streaming. In the example illustrated, cameras 922 are situated on a roof of a cab of the tractor. In other implementations, camera 922 may be provided at other alternative or additional locations on vehicle 920.

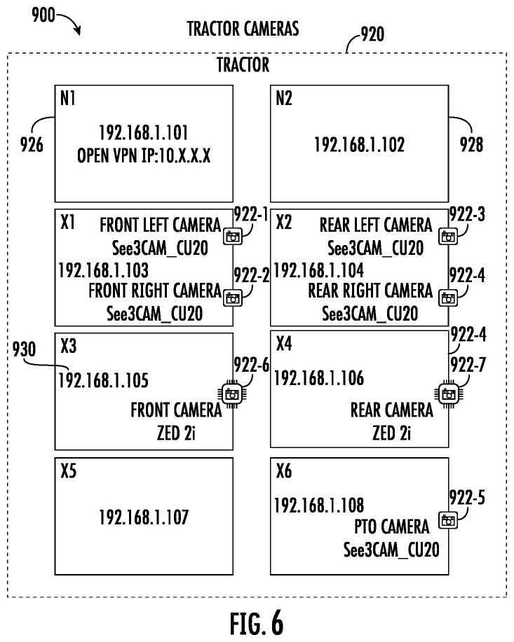

FIG. 6 is a schematic vehicle 920 and its cameras 922-1, 922-2, 922-3, 922-4, and 922-5. Cameras 922-1, 922-2, 922-3, 922-4 and 922-5 comprise two-dimensional cameras, whereas cameras 922-6 and 922-7 comprise three-dimensional or stereo cameras. Cameras 922-1, 922-2 and 922-6 have fields of view facing a front of vehicle 920. Cameras 922-3, 922-4 and 922-7 have fields of view facing a rear of vehicle 920. Camera 922-5 has a field-of-view encompassing the power takeoff located at the lower rear end of vehicle 920. Each of such cameras provide image signals that may be used for automated or remote control of vehicle 920, historical video storage for subsequent analytics, and image frame streaming for live viewing by an operator.

As further shown by FIG. 6, each of cameras 922 is associated with a computer 930 (processor and non-transitory computer-readable medium) having an identifier such as 192.168.1.105. In the example illustrated, the computers are provided with the cameras which are provided in the roof of the vehicle 920. In some implementations, the computers 930 comprise vehicle servers (labeled S3-S8 in FIG. 6).

Vehicle 920 further comprises vehicle servers 926 and 928. Such servers serve as web real time communication (RTC) servers to communicate with remote cloud-resources for vehicle controls communications. As will be described hereafter, in some implementations, such servers may comprise a video uploader which is part of a historical time clip storage system, and a Janus Gateway server.

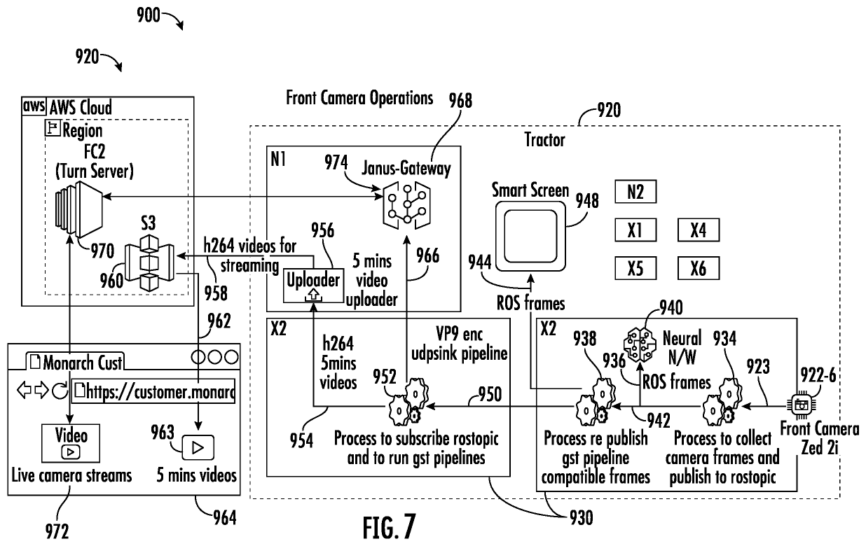

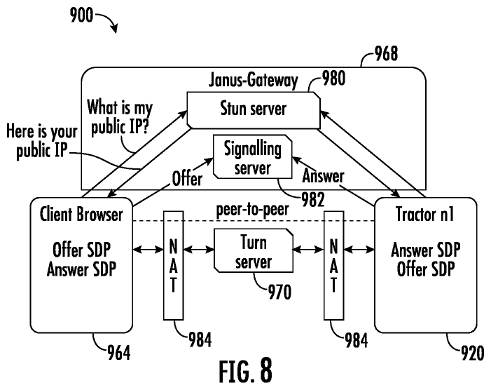

FIG. 7 is a diagram illustrating portions of system 900. FIG. 9 illustrates an image frame streaming system associated with camera 922-6. As shown by FIG. 7, vehicle 920 additionally comprises a second server S2 and additional computers (computer modules S4 and S6-S8) schematically illustrated in FIG. 6. Each of the additional computers (S4 and S6-S8) and the additional server S2 may function in the manner described below for the additional cameras 622. As a result, system 900 provides concurrent image frame streaming from multiple cameras on the vehicle to multiple consumers.

As shown by FIG. 7, computer 930 carries out several processes (schematically represented by gears). Computer 930 collects camera image frames from camera 922-6 and publishes them to rostopic (process 934). As indicated by arrow 936, a first stream of Robot Operating System (ROS) frames are created and transmitted to a first consumer in the form of a neural network 940 (machine learning). Such machine learning may be utilized as part of neural network training or as part of use of a neural network to carry out analytical operations. For example, neural network 940 may utilize the received ROS frames to identify crop, orchard or vineyard rows, to center a vehicle between such rows, to identify obstructions or obstacles and the like.

As indicated by arrow 942, computer 930 further carries out a process 938 which receives a second stream of ROS frames and republishes a second stream of ROS frames which are further republished into frames that are compatible with a multimedia framework, such as a G streamer pipeline-based multimedia framework. As indicated by arrow 944, a third stream of ROS frames are transmitted to a second consumer in the form of smart screen 948. Smart screen 948 comprises a display to present the received ROS frames. In some implementations, smart screen 948 and stream 944 may be omitted.

As indicated by arrow 950, computer 930 carries out process 952 to subscribe or receive the second stream of ROS frames to run the G streamer pipelines. As indicated by arrow 954, a first stream or pipeline from the multimedia framework (Gstreamer in the example) is transmitted as videos or video clips to a video uploader 956 which is part of a historical time clip storage system. As indicated by arrow 958, uploader 956 uploads the videos to a cloud-based storage 960. As indicated by arrow 962, such video clips 963 stored in storage 960 may be retrieved by a client/operator/manager browser 964 having a display for presentation to a person, such as an operator or manager. Although the video clips in the example are five minutes in length, in other implementations, the video clips may have other durations. The browser 964 may be part of a smart phone, a tablet computing device, a laptop computing device, a desktop computing device monitor, display screen or the like.

As indicated by arrow 966, a stream of image frames is further sent to the web RTC server 968. The web RTC server 968 cooperates with a cloud-based TURN server 970 and display 964 to provide sub second latency live meteor camera streams 972 which are presented on display 964.

FIG. 8 is a block diagram schematically illustrating an example live streaming architecture 974 of system 900. Architecture 974 comprises a web real time communication server 968 and TURN server 970. Server 968 may be in the form of a Janus Gateway, an open-source service. The web RTC server serves as a stun server 980 and a signaling server 982. The stunned server enables clients/operators to find out their public IP addresses, NAT type and Internet facing port associated by the NAT device with a particular local port. This information may be used to set up a UDP/TCP communication session between the peers, two endpoints, for peer-to-peer connection. In the example illustrated, the two peers are the vehicle/tractor 920 (vehicle computer) and the browser 964.

The signaling server is a server that manages a connection between peers. The signaling server does not deal with media traffic itself but takes care of signaling. Such signaling includes enabling one user to find another in the network, negotiating the connection itself, resetting the connection if needed and closing the connection down.

The Traversal Using Relays around NAT (TURN) server 970 is a protocol that assists in the traversal network address translator's (NAT) or firewalls 984 for WebRTC applications. The TURN server 970 facilitates ascending and transmission of data by clients through an intermediary server. In some implementations, the TURN protocol may be an extension to the STUN server.

In the example illustrated, a web RTC framework is built to serve as a powerful tool to infuse real time communication (RTC) capabilities into browsers, such browser 964 and mobile applications. The web RTC framework is implemented for live video streaming using the Janus Gateway 968. As noted above, Janus Gateway 968 serves as both the stun server and a signaling server, exchanging session description protocols (SDPs) in establishing connections between peers. Session description protocols are a set of rules and define how multimedia sessions can be set up to allow all endpoints (peers) to effectively participate in a session. A session may comprise a set of communication endpoints along with a series of interactions amongst them. A session may comprise a json object which contains information about a peer, such as public IP address, codec and the like, to facilitate peer-to-peer connections. The Janus Gateway server is configured on the vehicle/tractor 920 (the vehicle computer). The Traversal Using Relays around NAT (network address translation) (TURN) server is built or configured in a server in the cloud (such as Amazon cloud (AWS Cloud)). In some implementations, the TURN server may be established or created on a pool of computer instances which are mapped to a network load balancer.

On each of the computers associated with one of cameras 922, G streamer pipelines are executed. Payload of a pipeline is a video codec (VP9). The sink of each pipeline is udpsink (a network sink that sends UDP packets to the network). It can be combined with RTP payloaders to implement RTP streaming to transmit streams to VEHICLE COMPUTER private ip using respective ports. The vehicle side of the WebRTC Framework 968 listens to the ports to determine which computers 930 (Computer's) are transmitting streams to process the same to a connected peer. When an offer from the client browser 964 and an answer from the tractor NUC1 are exchanged, signaling server 982 establishes the shortest possible connection between both of the peers (browser 964 and tractor/vehicle 920) to facilitate communication.

In some implementations, a pool of computer instances or TURN servers may be prepared. Load-balancing may be carried out by using an available one of the TURN servers. In some implementations, the TURN server listener group may be auto scaled. In some implementations, the TURN server 970 ( ) may be monitored. If the TURN server 970 dies, auto healing may be performed. In some implementations, if the vehicle/tractor 920 Internet speed is less than 10 Mb per second, streaming may be discontinued or restricted to a portion of cameras 922. In some implementations, the transmit streams may be based upon Wi-Fi speed of the tractor/vehicle 920, providing adaptive bit rate. In some implementations, a user may log into the system for such live streaming. In some implementations, the TURN server 970 may be configured as a service (server last). In such implementations, the TURN server may be secured against public use.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. An image frame streaming system comprising:
a vehicle;
a video camera carried by the vehicle to output image frames;
a multi-media framework carried by the vehicle and configured to generate a first stream and a second stream from the image frames;
a first consumer to receive the first stream and a second consumer to receive the second stream,
wherein the first consumer and the second consumer are each selected from a group of consumers consisting of:
a neural network; a live video stream presenter; and a
historical time clip storage.

2. The image frame streaming system of claim 1, wherein the multi-media framework is configured to generate a third stream from the image frames, the system further comprising a third consumer to receive the third stream, wherein the third consumer is selected from the group of consumers consisting of: the neural network; the live video stream; and the historical time clip storage.

3. The image frame streaming system of claim 2, wherein the multimedia framework comprises a GStreamer pipeline-based multimedia framework.

4. The image frame streaming system of claim 1, wherein the first consumer comprises the live video stream presenter, the live video stream presenter comprising a web real time communication (RTC) server carried by the vehicle.

5. The image frame streaming system of claim 4, wherein the web RTC server comprises a Janus Gateway server.

6. The image frame streaming system of claim 1, wherein the live stream video presenter further comprises:
a cloud-based media server to receive the first stream from the web RTC server; and
a live stream display device to receive the first stream from the media server and display the live stream to a person.

7. The image frame streaming system of claim 1, wherein the second consumer comprises the historical time clip storage, the historical time clip storage comprising:
a video clip uploader carried by the vehicle and configured to receive a video clip based on the second stream;
a cloud-based storage configured to receive the video clip from the video clip uploader; and
a video clip display device to receive the video clip from the cloud-based storage and display the video clip to a person.

8. The image frame streaming system of claim 1, wherein the first consumer comprises the live video stream presenter, the live video stream presenter comprising a web real time communication (RTC) server carried by the vehicle, wherein the second consumer comprises the historical time clip storage, the historical time clip storage to receive the second stream, wherein the multi-media frame work is configured to generate a third stream from the image frames, the system further comprising a third consumer to receive the third stream, wherein the third consumer comprises a neural network.

9. The image frame streaming system of claim 8, wherein the historical time clip storage comprises:
a video clip uploader carried by the vehicle and configured to receive a video clip based on the second stream;
a cloud-based storage configured to receive the video clip from the video clip uploader; and
a video clip display device to receive the video clip from the cloud-based storage and display the video clip to a person.

10. The image frame streaming system of claim 8, wherein the live stream video presenter further comprises:
a cloud-based media server to receive the first stream from the web RTC server; and
a live stream display device to receive the first stream from the media server and display the live stream to a person.

11. The image frame streaming system of claim 1, further comprising:
a first web real time communication server carried by the vehicle to receive the first stream;
a second video camera carried by the vehicle to output second image frames;
a second multi-media framework carried by the vehicle and configured to generate a third stream and a fourth stream from the second image frames; and
a second web real time communication server carried by the vehicle to receive the third stream.

12. An image frame streaming method comprising:
capturing image frames with a camera carried by a vehicle;
generating a first stream and a second stream from the image frames with a multimedia framework;
transmitting the first stream to one of a neural network, a live video stream presenter and a historical time clip storage; and
transmitting the second stream to another of the neural network, the live video stream presenter and the historical time clip storage.

13. The image frame streaming method of claim 12, wherein the historical time clip storage comprises a cloud-based server.

14. The image frame streaming method of claim 12, wherein the live video stream presenter comprises a web real time communication (RTC) server carried by the vehicle.

15. The image frame streaming method of claim 12 further comprising generating a third stream from the image frames with the multimedia framework, wherein the first stream is transmitted to the neural network, the second stream is transmitted to the live video stream presenter and the third stream is transmitted to the historical time clip storage.
